(19) United States
(12) Patent Application Publication
(10) Pub. No.: US 2025/0374374 A1
(43) Pub. Date: Dec. 4, 2025

(54) EMERGENCY CALL CONTINUITY FOR INBOUND ROAMING UES

(71) Applicant: T-Mobile USA, Inc., Bellevue, WA (US)

(72) Inventors: Khurram Ahmad Mirza, Bellevue, WA (US); Madhuri Kotta, Bellevue, WA (US); Dinko Dinkov, Kirkland, WA (US); Alejandro Lucero, Maple Valley, WA (US)

(21) Appl. No.: 18/678,566

(22) Filed: May 30, 2024

(51) Int. Cl. H04W 76/50; H04L 41/5009; H04L 65/1016; H04W 8/12

(52) U.S. Cl. CPC H04W 76/50; H04L 41/5009; H04L 65/1016; H04W 8/12

(57) ABSTRACT

Described herein is an Internet Protocol (IP) multimedia subsystem (IMS) node configured to receive a call request from an inbound roaming user equipment (UE) and determine that a called party identifier in the call request corresponds to an emergency number. The emergency number is associated with geographic entity in which a home network of the inbound roaming UE is located. In response to the determining, the IMS node sends the call request to an emergency call session control function (E-CSCF) for routing to a public service answering point (PSAP).

### BACKGROUND

As people travel between countries and across jurisdictional boundaries, they move from a place with one emergency number or set of emergency numbers to another with different number(s). These travelers being along their user equipments (UEs), such as mobile phones, and often use their UEs at their destinations. In doing so, they become “inbound roamers” with respect to the cellular network(s) at their destinations. If their home networks are operated by roaming partners of the destination cellular network(s), the UEs may connect to and receive service from the destination cellular network(s).

Often, travelers may not be aware of the emergency numbers used at their destinations. For instance, “911” is a common emergency number in the United States, but it may not be known to a person traveling to the United States from another country. When such a traveler experiences an emergency and tries to call an emergency number known to the traveler but not to the cellular network he or she is connected to in the United States, the emergency call may fail.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIGS. 1A-1B are overview diagrams of emergency calling results for inbound roaming UEs based on whether an Internet Protocol multimedia subsystem (IMS) node is provisioned with an emergency number known to a user of the inbound roaming UE.

FIG. 2 is a network diagram of a telecommunications network with an IMS node implementing a proxy call session control function (P-CSCF), the P-CSCF in communication with an inbound roaming UE and an emergency call session control function (E-CSCF) and storing an emergency number known to a user of the inbound roaming UE.

FIG. 3 is a flow diagram of an illustrative process for determining that a called party identifier in a call request from an inbound roaming UE corresponds to an emergency number, where the emergency number is associated with geographic entity in which a home network of the inbound roaming UE is located.

FIG. 4 is a schematic diagram of a computing device, such as an IMS node, capable of implementing functionality of a P-CSCF.

### DETAILED DESCRIPTION

This disclosure is directed in part to an Internet Protocol (IP) multimedia subsystem (IMS) node configured to receive a call request from an inbound roaming user equipment (UE) and determine that a called party identifier in the call request corresponds to an emergency number. The emergency number is associated with geographic entity in which a home network of the inbound roaming UE is located. In response to the determining, the IMS node sends the call request to an emergency call session control function (E-CSCF) for routing to a public service answering point (PSAP). In some implementations, the receiving of the call request, the determining that the called party identifier corresponds to the emergency number, and the sending of the call request to the E-CSCF are performed by a proxy call session control function (P-CSCF) implemented by the IMS node.

In various implementations, the emergency number may be received from a roaming partner operating the home network of the inbound roaming UE. For example, the emergency number may be received from the roaming partner as part of an onboarding process following an agreement between the roaming partner and the network operator of the telecommunications network that includes the IMS node. The roaming partner may identify any emergency number(s) used in the geographic entity (e.g., country) in which its home network operates, and these may be provisioned to IMS nodes (e.g., those implementing P-CSCFs) throughout the telecommunications network of the network operator. Upon receiving the emergency number, an IMS node may store the emergency number in an emergency number profile database of that IMS node.

In some implementations, other sources (e.g., an artificial intelligence (AI) component, such as a generative AI) can provide emergency numbers associated with roaming partners and/or others to the IMS node.

In further implementations, the inbound roaming UE may subscribe to circuit-switched services of the roaming partner operating the home network of the inbound roaming UE. When roaming, the inbound roaming UE may thus connect to the IMS node through a circuit-switched connection of the telecommunications network.

Following the call request and determination that the called party identifier corresponds to the emergency number, the IMS node may perform one or more operations. For example, the IMS node may modify the call request to include a SOS URI (uniform resource identifier) parameter that may signal to the E-CSCF that the call request is for an emergency call. In further examples, the IMS node may add a local equivalent emergency number to the call request or replace the emergency number in the call request with the local equivalent emergency number.

While receiving the call request, determining that it is to an emergency number, and forwarding the call request to the E-CSCF, the IMS node may receive other call requests. Some of these may also be for emergency calls and may be forwarded on to the E-CSCF. Others may be to called party identifiers that do not match any emergency numbers known to the IMS node.

When these called party identifiers conform to expected conventions for called party identifiers, they are routed as non-emergency calls. When the called-party identifiers do not conform to conventions or match known emergency numbers, the IMS node may reject the calls corresponding to the call requests.

Also, while in operation, the IMS node may track key performance indicators (KPIs) for emergency calls, such as call attempts, successful calls, call failure percentage, etc. In some implementations, such KPIs may be shared with roaming partners or other parties.

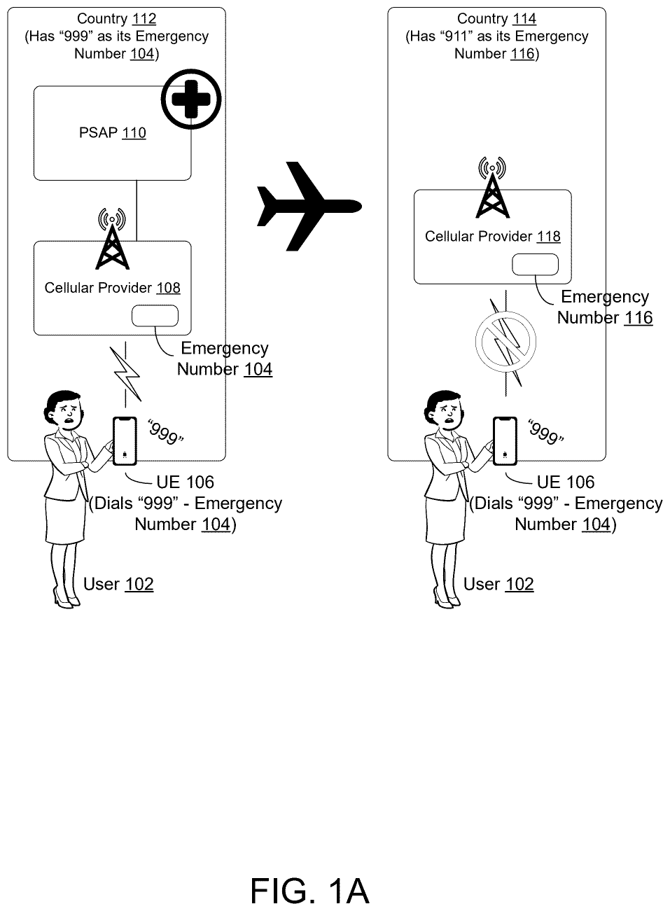

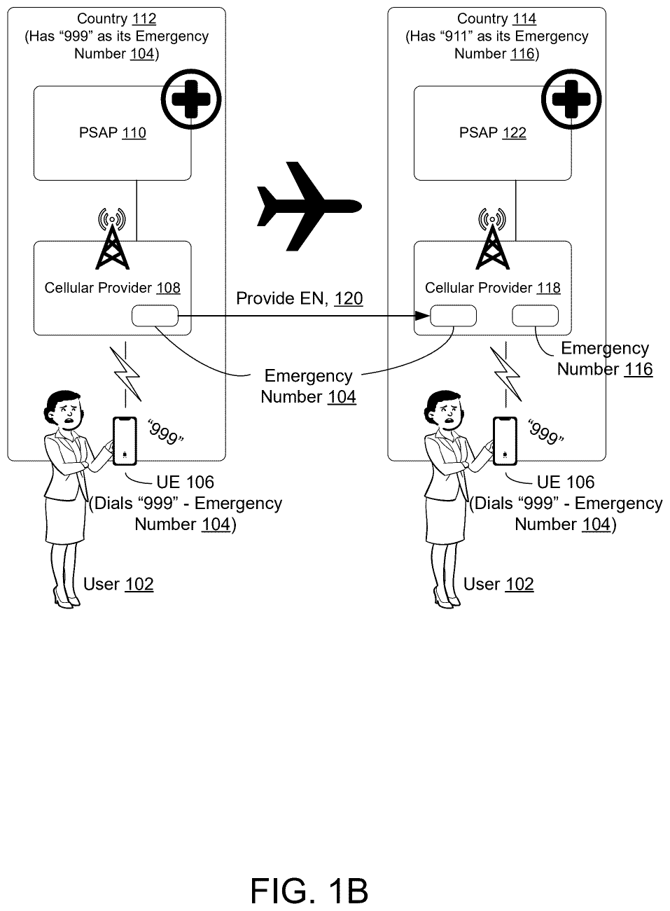

FIGS. 1A-1B are overview diagrams of emergency calling results for inbound roaming UEs based on whether an IMS node is provisioned with an emergency number known to a user of the inbound roaming UE. FIG. 1A illustrates an inbound roaming UE that is unable to make an emergency call on a network it is roaming to in a different country because that roaming network does not know that the number dialed is an emergency number. As shown, a user 102 may dial an emergency number 104 using her UE 106 (also referred to as “inbound roaming UE 106”). The UE 106 may connect to its cellular provider 108 (also referred to as “roaming partner”) to place a call to a PSAP 110. The emergency number 104 dialed by the user 102 may be a known emergency number in the country 112 of the user 102 which is recognized by the cellular provider 108.

Following travel of the user 102 with her UE 106 to another country 114, the UE 106 is now an inbound roaming UE 106. The country 114 may have a different, known emergency number 116 (e.g., “911”) and the user 102, perhaps finding herself in another emergency situation, may dial the emergency number 104 that is known to her rather than the emergency number 116 that is known in the country 114. If her cellular provider 108 is a roaming partner of a cellular provider 118 in the country 114 which provides her with service, she may connect to the cellular provider 118, sending a call request that specifies emergency number 104 as the called party. The cellular provider 118 may fail to recognize the emergency number 104 as either an emergency number or a valid number and may deny the call request, resulting in a failure of the emergency call.

FIG. 1B illustrates an inbound roaming UE that is able to make an emergency call on a network it is roaming to in a different country because that roaming network knows that the number dialed is an emergency number. As illustrated, the cellular provider 108 may be a roaming partner (“roaming partner”) of the cellular provider 118 and, as part of an onboarding process or later, may provide, at 120, the emergency number 104 to the cellular provider 118. The cellular provider 118 may then store the emergency number 104 (e.g., in an emergency number profile) and, when an emergency call is made by user 102 as an inbound roamer on her inbound roaming UE 106 in country 114, the cellular provider 118 may determine that the emergency number 104 dialed as the called party corresponds to a known emergency number in the emergency number profile. The cellular provider 118 may then place the call to a PSAP 122. The result is that the emergency number 104 of country 112 results in similar treatment in country 114 as a call made with the emergency number 116 of the country 114.

In some implementations, the user 102 may subscribe to circuit-switched services from the cellular provider 108 and connect to its home network in country 112 using circuit-switched connections. When roaming in country 114, the cellular provider 118 may enable the inbound roaming UE 106 to connect over a circuit-switched radio access network but a provide packet-switched connection over a core network through an IMS of the core network. That IMS may include one or more IMS nodes, and those one or more IMS nodes may implement a P-CSCF and E-CSCF. The emergency call may be received at the P-CSCF, which may determine that the called party identifier in the call request for the emergency call correspond to an emergency number known to the P-CSCF, such as emergency number 104 or emergency number 116. In response, the P-CSCF sends the call request to the E-CSCF, which places the emergency call to the PSAP 122.

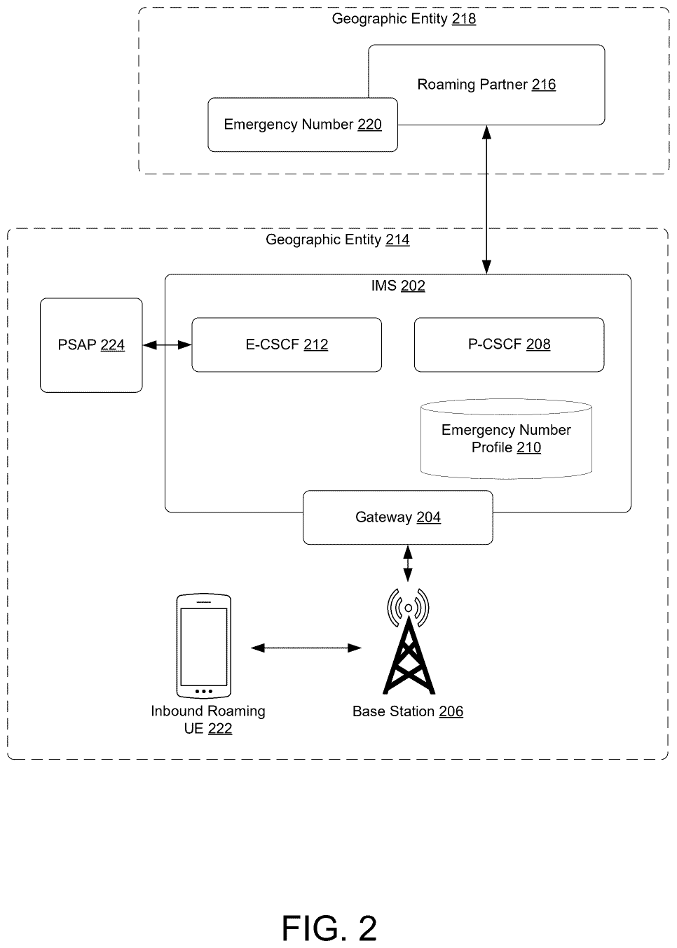

FIG. 2 is a network diagram of a telecommunications network with an IMS node implementing a P-CSCF, the P-CSCF in communication with an inbound roaming UE and an E-CSCF and storing an emergency number known to a user of the inbound roaming UE. As illustrated, an IMS 202, representing one or more IMS nodes, may be connected through a gateway 204 to a base station 206. The IMS 202 may include a P-CSCF 208, an emergency number profile 210, and an E-CSCF 212. The IMS 202 may be operated be a telecommunications network (e.g., a telecommunications network of cellular provider 118) in a geographic entity 214 (e.g., country 114). The cellular provider operating the telecommunications network that includes IMS 202 may have a roaming partner 216 (e.g., cellular provider 108) that operates in a different geographic entity 218 (e.g., country 112) and identifies an emergency number 220 (e.g., emergency number 104) to the cellular provider operating the telecommunications network that includes IMS 202. The IMS 202 is provisioned with the emergency number 220, stores it, and upon receiving a call request from an inbound roaming UE 222 (e.g., UE 106) that specifies the emergency number 220 as the called party, routes the call request to a PSAP 224 (e.g., PSAP 122).

In various implementations, the IMS 202 may be connected to other nodes of a core network of a telecommunications network. Such a core network may be a Fourth Generation (4G) core network, a Fifth Generation (5G) core network, a Sixth Generation (6G) core network, an earlier or later generation of core network, or a converged core network, including nodes from multiple generations of core networks. The gateway 204 may be a part of such a core network or may be an edge element in addition to it, providing access and, e.g., protocol translation to an external radio access network (RAN), such as the RAN provided by the base station 206. Such a RAN may be of the same generation as the core network or of a different generation. For example, the core network could be a 4G or 5G core network, and the access network could be a circuit-switched, Third Generation (3G) RAN. In such examples, the gateway 204 may be a computing device third bridges access both from inside a core network to outside of it and from one generation of technology to another.

The base station 206 providing the RAN may be any generation of base station. For example, if the RAN is a 3G RAN, the base station 206 may be a NodeB (NB). If the RAN is a 4G RAN, the base station 206 may be an eNodeB (eNB). If the RAN is a 5G RAN, the base station 206 may be a gNodeB (gNB). The base station 206 may be configured to send and receive radio frequency (RF) transmissions over one or more bands of RF spectrum that may be licensed to or associated with the cellular provider (e.g., cellular provider 118) operating the IMS 202, gateway 204, and base station 206. Such RF transmissions may provide the mechanism of connection with and communication with the inbound roaming UE 222. Wired or wireless backhaul may connect the base station 206 to one or more other nodes, such as the gateway 204, nodes of the IMS 202, or other nodes of the core network.

As shown in FIG. 2, the IMS 202 includes at least the P-CSCF 208, emergency number profile 210, E-CSCF 212. The IMS 202 may also include other functions, such as a serving call session control function (S-CSCF), an interrogating call session control function (I-CSCF), etc. which may provide IP/packet-based services and connections through the core network. As noted previously, these functions may be implemented on one or multiple IMS nodes that collectively implement the IMS 202.

The P-CSCF 208 includes or is connected to the emergency number profile 210. The emergency number profile 210 is a database which includes a list of emergency numbers known to the IMS 202 and may, in some implementations, include further data associated with emergency numbers. For example, if an emergency number stored by the emergency number profile 210 is received from a roaming partner 216 from a different geographic entity 218, the emergency number profile 210 may have a local equivalent emergency number mapped to the received emergency number.

The P-CSCF 208 may otherwise serve as a session initiation protocol (SIP) proxy along a signaling path for a connection of a UE 222 into the IMS 202. In the various implementations discussed herein, it also has the additional role of evaluating the called party identifier in a call request associated with a UE 222 and routing or rejecting the call request based on with the called party identifier is a conforming number (e.g., has the form of a mobile station international subscriber directory number (MS-ISDN), international mobile subscriber identity (IMSI), an IP multimedia public identity (IMPU), an IP multimedia private identity (IMPI), etc.) or a known emergency number or short code number. The P-CSCF 208 may respond to other calls not meeting such criteria with a rejection.

In some implementations, the cellular provider may provision the P-CSCF 208, through storing in the emergency number profile 210, emergency numbers. Initially, such provisioned numbers may include those used in the geographic entity 214 in which the cellular provider operates. For instance, if the geographic entity 214 is the United States, the provisioned emergency number(s) may include “911”. The provisioned emergency number(s) may also include those received from roaming partners (e.g., emergency number 220 from roaming partner 216). Such number(s) may be provided as part of an onboarding process for the roaming partner.

The P-CSCF 208, upon receiving a call request, may at some stage in processing the called party identifier compare it to emergency number(s) in the emergency number profile 210 (e.g., emergency number 220). Upon determining that the called party identifier corresponds to an emergency number in the emergency number profile 210, the P-CSCF 208 may add a SOS URI to the call request. The SOS URI may indicate to the E-CSCF 212, when it receives the call request, that the call request is for an emergency call. The P-CSCF 208 may add the SOS URI to the call request before sending the call request to the E-CSCF 212. In some implementations, the P-CSCF 208 adds a local equivalent emergency number to the call request or replaces the emergency number in the call request with the local equivalent emergency number (e.g., adds “911” to the call request or replaces “999” with “911”). As previously mentioned, the local equivalent emergency number may be mapped to the emergency number 220 received from the roaming partner 216 in the emergency number profile 210. The local equivalent emergency number may be added, for instance, by the cellular provider when provisioning the P-CSCF 208.

In various implementations, after the P-CSCF 208 sends the call request to the E-CSCF 212, the E-CSCF 212 may determine that the call request is for an emergency call and route the call request to a PSAP 224 which, upon responding and establishing the emergency call, is able to provide emergency services to the user of the UE 222. In some implementations, if a local equivalent emergency number is provided and there are multiple local equivalent emergency numbers, the local equivalent emergency number may be used to select among multiple PSAPs 224 to route the emergency all to (e.g., one associated with police, another with emergency medical services) or may be provided to a single PSAP 224 to aid with dispatch of the appropriate type of medical services.

In some implementations, the P-CSCF 208 may track one or more KPIs for emergency calls-for instance, number of call attempts, number of successful calls, percentage of call failures, etc. The cellular provider may report these KPIs to the roaming partner 216 periodically or from time to time.

In various implementations, the geographic entities 214 and 218 may be different countries (as, for example, in FIGS. 1A-1B) or other different types of jurisdictions (e.g., different states, provinces, counties, etc.). The roaming partner 216 may be a cellular provider like, e.g., cellular provider 108 that operates a telecommunications network in the geographic entity 218. The user of the inbound roaming UE 222 may be a subscriber to the roaming partner 216 and the telecommunications network of the roaming partner 216 may be the home network of the UE 222. The emergency number 220 used in the geographic entity 218 may be recognized and used on the telecommunications network of the roaming partner 216 as the emergency number.

The roaming partner 216, upon entering into a roaming agreement with the cellular provider operating the IMS 202, may be engaged in an onboarding process and provide the emergency number 220 to the cellular provider operating the IMS 202 in that onboarding process. For example, the emergency number 220 and any other emergency numbers used by subscribers of the roaming partner 216 may be identified (e.g., through a form or user interface) and, through one or more systems of the cellular provider operating the IMS 202, may be received at a provisioning system to be provisioned to P-CSCFs, including P-CSCF 208 of the telecommunications network of that cellular provider. The P-CSCFs may then store the emergency number 220 in the emergency number profiles (including emergency number profile 210).

In some implementations, additional emergency number(s) may be suggested to the cellular provider operating the IMS 202 by an artificial intelligence (AI) component (e.g., a generative AI). These may be based on the roaming partner 216, the geographic entity 218, the geographic entity 214, the identity of the cellular provider operating the IMS 202, or other factor(s). Such additional emergency number(s) may also be provisioned to the P-CSCF 208 and stored in the emergency number profile 210.

In various implementations, the inbound roaming UE 222 may be any sort of computing device capable of wireless communication such as a mobile phone, tablet computer, watch, goggles, Internet-of-Things (IoT) device, personal computer, etc. The UE 222 may be an example of a UE 106. As shown in FIG. 2, the UE 222 may be connected to the base station 206 via a wireless connection over a radio frequency.

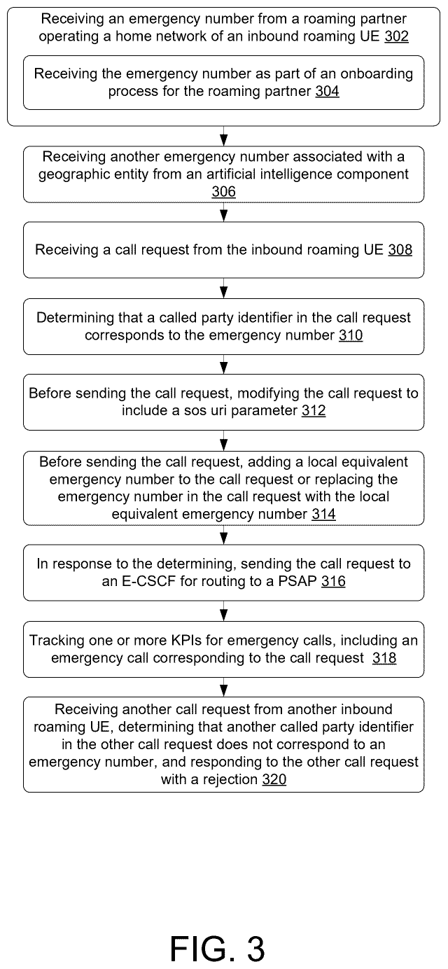

FIG. 3 illustrates an example process. This process is illustrated as logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 3 is a flow diagram of an illustrative process for determining that a called party identifier in a call request from an inbound roaming UE corresponds to an emergency number, where the emergency number is associated with geographic entity in which a home network of the inbound roaming UE is located. As illustrated at 302, an IMS node of an IMS may receive an emergency number from a roaming partner operating a home network of an inbound roaming UE. At 304, the receiving may include receiving the emergency number as part of an onboarding process for the roaming partner. In some implementations, the IMS node may implement a proxy call session control function (P-CSCF) to perform the operations of FIG. 3.

At 306, in some implementation, the IMS node may receive another emergency number associated with a geographic entity from an artificial intelligence component.

At 308, the IMS node receives a call request from the inbound roaming UE. In some implementations, the inbound roaming UE subscribes to circuit-switched services of the roaming partner operating the home network of the inbound roaming UE, and the inbound roaming UE is connected to the IMS node through a circuit-switched connection.

At 310, the IMS node determines that a called party identifier in the call request corresponds to the emergency number. The emergency number may be stored in an emergency number profile database of the IMS node.

At 312, before sending the call request, the IMS node may modify the call request to include a SOS URI parameter.

At 314, in some implementations, before sending the call request, the IMS node may add a local equivalent emergency number to the call request or replace the emergency number in the call request with the local equivalent emergency number.

At 316, in response to the determining at 310, the IMS node sends the call request to an E-CSCF for routing to a PSAP.

At 318, the IMS node may track one or more KPIs for emergency calls, including an emergency call corresponding to the call request.

At 320, the IMS node may receive another call request from another inbound roaming UE, determine that another called party identifier in the other call request does not correspond to the emergency number or to another emergency number, and respond to the other call request with a rejection.

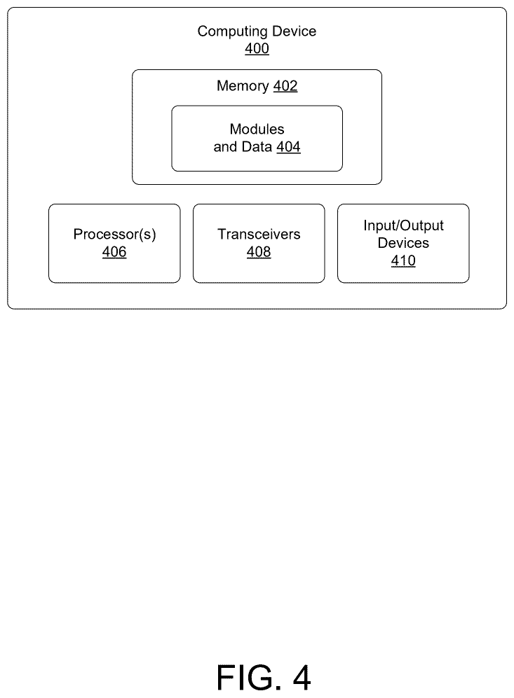

FIG. 4 is a schematic diagram of a computing device, such as an IMS node, capable of implementing functionality of a P-CSCF. As shown, the computing device 400 includes a memory 402 storing modules and data 404, processor(s) 406, transceivers 408, and input/output devices 410.

In various examples, the memory 402 can include system memory, which may be volatile (such as RAM), non-volatile (such as ROM, flash memory, etc.) or some combination of the two. The memory 402 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 402 can include one or more software or firmware elements, such as computer-readable instructions that are executable by the one or more processors 406. For example, the memory 402 can store computer-executable instructions associated with modules and data 404. The modules and data 404 can include a platform, operating system, and applications, and data utilized by the platform, operating system, and applications. Further, the modules and data 404 can implement any of the functionality for the UE 106, device(s) of the cellular provider 108, device(s) of the PSAP 110, device(s) of the cellular provider 118, device(s) of the PSAP 122, IMS node(s) implementing IMS 202, the gateway 204, the base station 206, device(s) implementing a telecommunications network of the roaming partner 216, inbound roaming UE 222, device(s) implementing the PSAP 224, or any other node/device described and illustrated herein.

In various examples, the processor(s) 406 can be a central processing unit (CPU), a graphics processing unit (GPU), or both CPU and GPU, or any other type of processing unit. Each of the one or more processor(s) 406 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 406 may also be responsible for executing all computer applications stored in the memory 402, which can be associated with types of volatile (RAM) and/or nonvolatile (ROM) memory.

The transceivers 408 can include modems, interfaces, antennas, Ethernet ports, cable interface components, and/or other components that perform or assist in exchanging wireless communications, wired communications, or both.

While the computing device need not include input/output devices 410, in some implementations it may include one, some, or all of these. For example, the input/output devices 410 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 410 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 410 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

What is claimed is:

1. A method comprising:
receiving, by an Internet Protocol (IP) multimedia subsystem (IMS) node, a call request from an inbound roaming user equipment (UE);
determining, by the IMS node, that a called party identifier in the call request corresponds to an emergency number, wherein the emergency number is associated with geographic entity in which a home network of the inbound roaming UE is located; and
in response to the determining, sending, by the IMS node, the call request to an emergency call session control function (E-CSCF) for routing to a public service answering point (PSAP).

2. The method of claim 1, wherein the receiving, the determining, and the sending are performed by a proxy call session control function (P-CSCF) implemented by the IMS node.

3. The method of claim 1, further comprising receiving the emergency number from a roaming partner operating the home network of the inbound roaming UE.

4. The method of claim 3, wherein the receiving comprises receiving emergency number as part of an onboarding process for the roaming partner.

5. The method of claim 1, further comprising, before sending the call request, modifying the call request to include a SOS URI (uniform resource identifier) parameter.

6. The method of claim 1, wherein the inbound roaming UE subscribes to circuit-switched services of a roaming partner operating the home network of the inbound roaming UE, and the inbound roaming UE is connected to the IMS node through a circuit-switched connection.

7. The method of claim 1, wherein the emergency number is stored in an emergency number profile database of the IMS node.

8. The method of claim 1, further comprising tracking one or more key performance indicators (KPIs) for emergency calls.

9. The method of claim 1, further comprising receiving another emergency number associated with the geographic entity or another geographic entity from an artificial intelligence component.

10. The method of claim 1, further comprising, before sending the call request, adding a local equivalent emergency number to the call request or replacing the emergency number in the call request with the local equivalent emergency number.

11. The method of claim 1, further comprising receiving another call request from another inbound roaming UE, determining that another called party identifier in the other call request does not correspond to the emergency number or to another emergency number, and responding to the other call request with a rejection.

12. An Internet Protocol (IP) multimedia subsystem (IMS) node comprising:
one or more processors; and
a plurality of programming instructions that, when executed by the one or more processors, cause the IMS node to perform operations comprising:
receiving a call request from an inbound roaming user equipment (UE);
determining that a called party identifier in the call request corresponds to an emergency number, wherein the emergency number is associated with geographic entity in which a home network of the inbound roaming UE is located; and
in response to the determining, sending the call request to an emergency call session control function (E-CSCF) for routing to a public service answering point (PSAP).

13. The IMS node of claim 12, wherein the plurality of programming instructions implement a proxy call session control function (P-CSCF) to perform the receiving, the determining, and the sending.

14. The IMS node of claim 12, wherein the operations further comprise receiving the emergency number from a roaming partner operating the home network of the inbound roaming UE.

15. The IMS node of claim 12, wherein the operations further comprise, before sending the call request, modifying the call request to include a SOS URI (uniform resource identifier) parameter.

16. The IMS node of claim 12, wherein the inbound roaming UE subscribes to circuit-switched services of a roaming partner operating the home network of the inbound roaming UE, and the inbound roaming UE is connected to the IMS node through a circuit-switched connection.

17. The IMS node of claim 12, further comprising an emergency number profile database for storing emergency numbers, wherein the emergency number is stored in the emergency number profile database.

18. A non-transitory computer storage medium having plurality of programming instructions stored thereon that, when executed by one or more processors of an Internet Protocol (IP) multimedia subsystem (IMS) node, cause the IMS node to perform operations comprising:
receiving a call request from an inbound roaming user equipment (UE);
determining that a called party identifier in the call request corresponds to an emergency number, wherein the emergency number is associated with geographic entity in which a home network of the inbound roaming UE is located; and
in response to the determining, sending the call request to an emergency call session control function (E-CSCF) for routing to a public service answering point (PSAP).

19. The non-transitory computer storage medium of claim 18, wherein the operations further comprise tracking one or more key performance indicators (KPIs) for emergency calls.

20. The non-transitory computer storage medium of claim 18, wherein the operations further comprise receiving another call request from another inbound roaming UE, determining that another called party identifier in the other call request does not correspond to the emergency number or to another emergency number, and responding to the other call request with a rejection.
